(19) United States
(12) Patent Application Publication
(10) Pub. No.: US 2026/0316768 A1
(43) Pub. Date: Oct. 15, 2026

(54) ACTIVATION OF FUNCTIONS IN MOTOR VEHICLES

(71) Applicant: Ford Global Technologies, LLC, Dearborn, MI (US)

(72) Inventors: Hans Guenter Quix, Herzogenrath/NRW (DE); Markus Espig, Aachen/NRW (DE); David van Bebber, Aachen/NRW (DE)

(73) Assignee: Ford Global Technologies, LLC, Dearborn, MI (US)

(21) Appl. No.: 19/640,845

(22) Filed: Apr. 7, 2026

(30) Foreign Application Priority Data
Apr. 15, 2025 (DE) 102025114701.9

(51) Int. Cl. B60W 50/00; B60W 40/08; B60W 50/14; G09B 9/042

(52) U.S. Cl. CPC B60W 50/0098; B60W 40/08; B60W 50/14; G09B 9/042; B60W 2050/0083; B60W 2050/146; B60W 2556/45

(57) ABSTRACT

The disclosure concerns a method for activating functions in a motor vehicle, with which functions of the motor vehicle are immediately or only conditionally activated for a user of the motor vehicle. The following procedure is proposed:

classification of the functions of the motor vehicle into basic functions and extended functions;

first determination of which basic functions and/or which extended functions are free functions for the user of the motor vehicle which are immediately activated, and which basic functions and/or extended functions are functions to be activated which are only activated after successfully proven training;

second determination of a number of possible starts of the motor vehicle in which functions to be activated can be used provisionally and to a limited extent, wherein the functions to be activated are only fully activated after successfully proven training; and

activation of the free functions for the user upon the first use of the motor vehicle, activation of the functions to be activated upon successful proven training, or blocking of the functions to be activated upon reaching the number of possible starts.

### CROSS-REFERENCE TO RELATED APPLICATION

This patent application claims priority to German Application No. DE 102025114701.9 filed on Apr. 15, 2025, which is hereby incorporated by reference in its entirety.

### FIELD

The disclosure concerns a system and method for activating functions in motor vehicles.

### BACKGROUND

Motor vehicles are often equipped with a large number of functions, which are provided in particular by functions of various driver assistance systems. Driver assistance systems (DAS), which are also referred to as assistance systems for short, have a central control unit by means of which the functions offered are implemented in order to support a user of a motor vehicle, for example, in braking, lane keeping, automated driving or parking the motor vehicle. Such central control units are also referred to as control devices.

With the increasing complexity of such driver assistance systems, the demands on users of the motor vehicle are also increasing. In addition, the available functions differ from manufacturer to manufacturer, so that existing knowledge can only be transferred to other motor vehicles to a limited extent.

The available functions are usually illustrated and described in detail in a manual that is at least partially supplied with the motor vehicle. Before putting an unknown motor vehicle into service, the manual should therefore be read in order to familiarize the user with at least basic functions. Due to the volume of such manuals, which typically are available in print or also electronically in a PDF format, and often comprise about 500 pages or more, they are often not read in practice. Therefore, an owner and/or user of the motor vehicle may not have access to requisite information about the available functions of the motor vehicle.

Herein, a distinction is made between an owner of the motor vehicle and a driver or user of the motor vehicle who uses the motor vehicle with the consent of the owner. While the owner of the motor vehicle is usually well acquainted with the functions of the motor vehicle, users of the motor vehicle, especially if they have not driven the particular motor vehicle before, may be insufficiently informed or not informed at all about many functions.

Another problem with modern motor vehicles can be that functions can change due to a software update or that new functions are added through a software update. Information about updated functions cannot be found in the manual that is usually included at the time of sale or manufacture.

As a result of insufficient knowledge, users of the motor vehicle can be overwhelmed with the multitude of functions. Therefore, it may happen that the user is looking for functions or controls related to the functions while driving because he or she is not familiar with these functions.

An information system for a motor vehicle is known from DE 10 2005 0035 992 A1. This includes a data processing device and a display device for the presentation of stored information, which can be selected by means of an operating device and can be read from a memory device, wherein the information is that of an operating manual of the motor vehicle and when information is selected, the corresponding device in the motor vehicle can be activated.

Information that is usually given with the motor vehicle in a printed operating manual or handbook is also stored on a memory medium in electronic form, so that this information can be retrieved and made accessible to the user with a known information system, which is implemented in the form of an on-board computer, for example. For this purpose, this information is divided into different areas according to the structure in well-known operating instructions, which concern, for example, the interior equipment of the motor vehicle, the exterior equipment, safety devices, technical data, and others.

A motor vehicle with a driving mode and a simulation mode is known from DE 10 2005 0035 992 A1. The motor vehicle has a computer unit, a control device, a display device and a number of operating devices for the operation of the motor vehicle by a driver. The motor vehicle is set up to interpret inputs from the driver to the operating devices as driving commands in driving mode and to translate them into movements of the motor vehicle. Furthermore, in simulation mode, the motor vehicle is set up not to interpret all entries made by the driver to the operating devices as driving commands and not to translate them into movements of the motor vehicle. The control device is set up to receive a switching signal and, when the switching signal is received, to switch an operating mode of the motor vehicle between driving mode and simulation mode. The computer unit is set up to carry out an interactive simulation in simulation mode, wherein the interactive simulation simulates a journey with the motor vehicle as a virtual journey with a virtual motor vehicle and is set up to interpret input from the driver to the control devices in simulation mode as simulation commands with which the virtual motor vehicle is controlled in the simulation. The display device is set up to show the driver the virtual journey as a simulation output of the interactive simulation in simulation mode.

In view of the above, there is room for improvement in connection with the presented prior art in the field of methods for activating functions in motor vehicles and arrangements for the implementation of the method.

The disclosure herein includes a method for activating functions in motor vehicles and an arrangement for implementing the method, which enable individual classification of functions of the motor vehicle and individual adaptation of the conditions for the use of the functions of the motor vehicle. Furthermore, the operation of the motor vehicle is to be prevented in the event that a user has not yet completed training for certain basic functions that are fundamentally necessary for the operation of the motor vehicle. In addition, these possibilities of classification, adaptation and prevention are to be available only to an owner of the motor vehicle, wherein these classifications, adaptations and prevention determined by the owner apply to all users of the motor vehicle.

A method for activating functions in a motor vehicle is presented, with which functions of the motor vehicle are activated immediately or only conditionally for a user of the motor vehicle, including at least the following steps:
classification of the functions of the motor vehicle into basic functions and extended functions,
first determination of which basic functions and/or which extended functions are free functions for the user of the motor vehicle, which are immediately activated, and which basic functions and/or extended functions are functions to be activated, which are activated only after successfully proven training,
second, determination of a number of possible starts of the motor vehicle, with which functions to be activated can be used to a limited extent for the time being, wherein the functions to be activated are only fully activated after successfully proven training, and
activating the free functions for the user when using the vehicle for the first time, activating the functions to be activated upon successful proven training, or blocking the functions to be activated when the number of possible starts is reached.

Advantageous arrangements are disclosed in the dependent claims.

It should be noted that the features and measures listed individually in the following description can be combined with each other in any technically sensible way and reveal further embodiments The disclosure provides a method and also an arrangement (i.e., system) for activating functions in a motor vehicle. In this context, the term “motor vehicle” in the narrower sense refers to a road vehicle, i.e., a vehicle suitable and registered for road traffic with its own drive engine. The drive engine can be an internal combustion engine or a hybrid drive, including an internal combustion engine. The motor vehicle can also be an electric vehicle. In general, the term “electric vehicle” here refers to a vehicle that has at least one electric motor that serves to drive the vehicle. In particular, it can be a purely electrically powered vehicle. In particular, it can be a car, a truck, or a bus. Preferably, the motor vehicle has at least two axles, each with two wheels, but deviations from this are also conceivable. The motor vehicle can be controlled by a driver or user, at least temporarily. However, it can also be set up to drive autonomously, at least temporarily, i.e., without control by a user.

With a method for activating functions in a motor vehicle, functions of the motor vehicle are activated for a user of the motor vehicle, which means that the user of the motor vehicle can use the activated functions while operating the motor vehicle.

Such activation of a function of the motor vehicle can take place immediately, wherein the function is available to the user without restrictions when the motor vehicle is started for the first time.

Such activation of a function of the motor vehicle can be conditional, wherein the function is only available to the user if a specified condition such as instruction or successful training is met. If the user can prove that the training has been successfully completed, the corresponding function of the motor vehicle will be activated for this user after proof has been provided.

Alternatively, the activation of a function of the motor vehicle for which instruction or successful training must be proven can be limited, which means that the function is initially made available to the user to a limited extent. Such a restriction is, for example, a predetermined number of starts of the motor vehicle, after which the user must prove that the training has been successfully completed in order to be able to continue using the function permanently. In the event that the user does not prove that he has successfully completed training after the specified number of starts of the motor vehicle, the relevant function of the motor vehicle will be blocked for this user.

In an example with a number of three predetermined starts of the motor vehicle, the user must prove that the training has been successfully completed before the fourth start of the motor vehicle. In the event that the user does not provide proof of successfully completed training, the corresponding function of the motor vehicle will no longer be available to the user from the fourth start.

The available functions of the motor vehicle are divided into two groups. The first group, for example, is assigned basic functions that are indispensable for the operation of the motor vehicle. In addition, the owner of the motor vehicle can define other basic functions that are not absolutely necessary for the operation of the motor vehicle. The second group, for example, is assigned to extended functions. One design may provide that the functions indispensable for the operation of the motor vehicle are already defined as basic functions by a vehicle manufacturer. The owner of the motor vehicle cannot switch off such predefined basic functions or classify them in the extended functions. However, the owner of the motor vehicle can reduce the number of possible starts for a predefined basic function to zero and thus force training on this basic function before starting of the motor vehicle.

The terms “first”, “second”, etc. are used below and above for the purpose of distinction only. In particular, their use is not intended to imply the order or priority of the objects mentioned in connection with these terms.

Mentioned examples of basic functions include:
Operation of the interior air conditioning
Switching on the hazard warning lights
Windshield wiper function (permanent, interval, with rain sensor)

Mentioned examples of extended functions include:
Launch Control
High-beam assistant
Adaptive cruise control

Once this has been done, a first determination is still made as to which basic functions and/or which extended functions are free functions for the user of the motor vehicle. As already explained above, “free functions” are available to all users of the motor vehicle without restrictions from the first start of the motor vehicle, regardless of whether they are basic functions or extended functions.

It is also advantageous to make an initial determination of which basic functions and/or extended functions are functions to be activated. These functions to be activated are only available to a specific user of the motor vehicle after proof of successfully completed training for this user, regardless of whether they are basic functions or extended functions.

Furthermore, a second determination of a number of possible starts of the motor vehicle is made. This number of possible starts determines how often a function of the motor vehicle that is classified as a function to be activated can be used provisionally, i.e., to a limited extent, by the user before the use thereof is blocked for this user. If this user proves that the training has been successfully completed by the end of the specified number of starts of the motor vehicle, the corresponding function is activated for this user. This activation after successfully completing the training can affect all further starts of the motor vehicle.

The method according to the disclosure, which is implemented for example in a control device of a motor vehicle, causes activation of the free functions for all users of the motor vehicle at the first use of the motor vehicle. Furthermore, according to the method, the functions to be activated are activated for a specific user in the event of a successfully proven training of this specific user. In addition, the method blocks functions to be activated for those users of the motor vehicle who do not provide proof of successfully completed training by the expiry of the number of possible starts.

With a preferred design, the classification of functions and the first determination and the second determination is carried out by an owner of the motor vehicle for all users of the motor vehicle.

This allows the owner of the motor vehicle to individually classify the functions of the motor vehicle into basic functions and extended functions. Thus, it is also possible for the owner of the motor vehicle to change and thus adapt the classification of the functions of the motor vehicle into basic functions and extended functions over time, for example. Such an adjustment is necessary, for example, after a software update of the control devices of the motor vehicle. The individual classification of the functions of the motor vehicle may be limited in such a way that certain basic functions that are fundamentally necessary for the operation of the motor vehicle, such as a function of a hazard warning light system, cannot be switched off by the owner or moved from the basic functions to the extended functions. Such basic functions, which are fundamentally necessary for the operation of the motor vehicle, are determined, for example, by a manufacturer of the vehicle. However, the owner of the motor vehicle can also set the number of possible starts for these fundamentally necessary basic functions.

Such an adjustment can also be carried out if the group of users changes. For example, a group of users can be a family. Alternatively, a group of users can include strangers if the motor vehicle is offered by the owner of the motor vehicle as a rental vehicle, for example.

Such an adjustment can also be carried out, for example, if at certain times new functions that are not available in all motor vehicles and which can be found in modern motor vehicles of all manufacturers, become so-called basic or standard functions over time. For example, from 2024 onwards, motor vehicles in Europe will at least be equipped with functions of vehicle assistance systems such as an intelligent speed assistant (Intelligent Speed Assistance=ISA), a drowsiness warning, also known as attention monitoring, and a reversing assistant.

The first determination of which basic functions and/or which extended functions are free functions for the users of the motor vehicle and which basic functions and/or extended functions are functions to be activated is also carried out by the owner of the motor vehicle for all users of the motor vehicle. Thus, the owner of the motor vehicle can adapt the free functions of the motor vehicle for all users of the motor vehicle in a contemporary way or according to user groups.

Furthermore, the second determination of a number of possible starts of the motor vehicle, for which functions to be activated can be used to a limited extent for the time being, is also determined by the owner of the motor vehicle for all users of the motor vehicle. Thus, the owner of the motor vehicle can also adapt the number of possible starts of the motor vehicle for all users of the motor vehicle in a contemporary way or according to user groups.

It can be advantageous if the training for the functions to be activated is carried out in the motor vehicle, and the result of the training is assigned to a user and stored in a user account in the motor vehicle.

The training for the functions to be activated is carried out in the motor vehicle itself according to an initial variant. For this purpose, for example, the control device responsible for the functions to be trained is used according to the method. In this way, the corresponding functions are learned realistically in the environment of the motor vehicle, since inputs such as commands from the user and outputs such as representations of the corresponding function in the motor vehicle can be faithfully represented or simulated by the means of the motor vehicle itself.

It is envisaged that the basic functions and the extended functions will be weighted or numbered by the owner of the motor vehicle. For example, basic functions such as starting the motor vehicle may be at the beginning of the numbering system or may have lower numbers, while extended functions, such as air conditioning in different climate zones of the motor vehicle, may have a higher number.

In this way, the training for the user can be controlled and structured accordingly, wherein it is provided that basic functions are trained first.

If a specific user performs the training in the motor vehicle and is able to successfully complete this training, this successfully completed training will be stored for the specific user completing the training. An assignment to this specific user is made by means of a user-specific user account. In this user account, data about the successfully completed training courses are stored for the specific user and thus permanently proven. This user account may also store information about the classification of functions determined by the owner of the motor vehicle for this specific user, as well as the first and second determinations.

For example, in the event that several users drive a motor vehicle at different times, information about successfully proven training of a particular user is retained in his or her specific user account. On the next trip with the motor vehicle, the training can be continued on the basis of the level already reached.

In particular, it is envisaged that training in the motor vehicle will only be carried out when the motor vehicle is stationary. This ensures that the user is not distracted by training while driving the motor vehicle. For example, a training can only be performed when the automatic transmission is in a parking position, or the manual transmission is in a neutral position, or when a handbrake is applied and/or a parking brake is activated. In the event that the automatic transmission leaves the parking position or the handbrake and/or parking brake is released, ongoing training is stopped. In one example, it may be provided that the combustion engine is switched off or the electric motor is inactive in order to be able to carry out the training.

In an example, the training for the functions to be activated is carried out by means of a data processing device, and in the event of a successfully completed training, proof of the successfully completed training is output and assigned to a user account of the user.

The training for the functions to be activated is carried out according to a second variant by means of a data processing device and not in the motor vehicle itself. Such a data processing device is understood, for example, as a computer, laptop, tablet, or mobile phone, by means of which the user is directed to a corresponding application to carry out the training. Such an application or website is designed to simulate inputs such as user commands and outputs such as representations of the corresponding function in the motor vehicle.

If a specific user carries out the training by means of the mentioned application or website and is able to successfully complete this training, this successfully completed training will also be stored for the specific user completing the training. The assignment to this specific user is also made by means of the user-specific user account, in which the successfully completed trainings are stored and thus proven. For this purpose, the website issues proof of successfully completed training to the user account of the user, for example via a suitable interface.

To carry out the training, both a display of the corresponding data processing unit and a virtual reality application coupled to the data processing unit can be used. For example, virtual reality glasses are possible.

In a further example, it may be preferred that the output is made to a data carrier or that the output is made via an interface for wireless communication with the motor vehicle.

The proof of a training course successfully completed by means of a data processing device is output to a mobile data carrier. Such a mobile data carrier can be a USB stick, a chip card, or a memory card, on which information assigned to a user account of a specific user is stored permanently and in a readable form.

Such a data carrier is carried by the user and read according to the method via a suitable interface of the motor vehicle before a journey with the motor vehicle. In this way, in addition to freely available functions, the specific user is also provided with the basic functions and the extended functions for which the user has already completed the corresponding training.

A new training for the specific user on training units that have already been successfully proven no longer has to take place in this way, especially also in the event that the special user has carried out the training by means of a data processing device and not in a motor vehicle. Of course, the user is also provided with the basic functions to be activated and the extended functions to be activated, for which the number of possible starts specified in the second determination has not yet expired. For this purpose, information about the number of available or already used starts of the motor vehicle for basic functions to be activated and/or extended functions to be activated will also be stored in the user account.

In an alternative, the certificate of a training course successfully completed by means of a data processing device is issued via an interface to wireless communication. This interface is designed to exchange data with a suitable mobile data carrier or with the motor vehicle in accordance with a protocol for wireless data transmission. Such an exchange of data between the data processing device and the motor vehicle can be carried out, for example, by means of a WLAN protocol (Wireless Local Area Network). In this case, a corresponding interface is also provided in the motor vehicle for data transmission, for example according to the WLAN protocol.

Alternatively, data can be exchanged between the data processing device and a mobile data carrier of the user. In this case, the information is transferred from the data processing device to the user's mobile storage device, for example in accordance with an NFC (Near Field Communication) protocol, and is thus stored in the user's account on the user's mobile data carrier. In this case, an interface operating according to the NFC protocol is also provided in the motor vehicle for reading the information of the user account from the mobile data carrier. Other protocols suitable for mobile data transmission can also be used. There is no restriction to the examples mentioned here, WLAN and NFC.

It can be particularly advantageous if, in the event that a training course for a function has only been partially successfully completed, the function relating to the training is only partially and/or temporarily released.

In the event that functions of the motor vehicle can be used in sub-steps, according to the method these can be released or activated for a user in full or only partially with regard to the sub-steps. For example, in the case of a function that has two sub-steps to be activated, for which a user can prove successful training for the first sub-step, only the first sub-step of this function will be activated. Only after the user can prove successful training for the second sub-step of this function will the full activation of this function to be activated take place.

An example of a function to be activated that has such sub-steps can be a function for controlling a vehicle air conditioning system with several climate zones. The first sub-step concerns the control of the vehicle air conditioning system in general without the comfort of several climate zones in the motor vehicle, while the second sub-step concerns the specific control of the vehicle air conditioning system with all climate zones.

Another way to release functions to be activated is to activate a function for a limited time. In this way, it is achieved that the user must update his or her abilities to operate the function to be activated after a specified driving time in the motor vehicle or at prescribed intervals, since otherwise this function to be activated will be blocked for the user.

It is also advantageous that the information assigned to the user in the user account about successfully completed training courses for the functions to be activated is transferred to vehicles of the same type, which means that there is no need for this user to have to train again on vehicles of the same type.

As already described above, in a user account assigned to a specific user, in addition to the information about successfully completed training for the functions to be activated, information about the number of available or already used starts of the vehicle for basic functions to be activated and/or extended functions to be activated is stored in a user account assigned to a specific user. In addition, information about the classification of functions defined by the owner of the motor vehicle for this specific user, as well as the first definitions and the second definitions, may be also stored in the user account.

By storing all this information in the user account of a specific user, the user account can be used in different motor vehicles that the specific user wants to drive, for example at different time intervals. Such a user account can be stored, for example, on an external, mobile data carrier such as a USB stick, a memory card, a chip card, or a mobile phone of the user. To implement the method, the motor vehicles are equipped with a control device designed to store the information of several user accounts. In addition, the control device is connected to an interface via which information about a user account can be transferred from the control device to the external, mobile data carrier and vice versa.

Thus, the user can transfer the information about their user account, for example with a specific number of successfully proven training courses and the functions activated for this user, at least to identical motor vehicles of a certain manufacturer, and can use or drive this motor vehicle accordingly. In this way, a repetition of training courses on identical motor vehicles from a certain manufacturer is avoided and user-friendliness is achieved.

In the event that the user successfully proves further training units on further functions to be activated with the motor vehicle he or she is currently driving, his or her user account will be updated at least at the end of the journey with the motor vehicle. The user account information is also updated on the external, mobile data carrier.

This makes it possible, for example, for a specific user to advantageously use identical motor vehicles from one manufacturer that an owner of a vehicle rental company has in their inventory, for example at different locations. Especially when renting a vehicle, users can activate and use their personal settings or approvals of the functions of the motor vehicle. The same applies to a fleet of a company that, for example, manages company cars for users.

An arrangement (i.e., system) is described for the activation of functions in a motor vehicle, in particular set up to carry out the method according to one of the preceding designs or combinations thereof, wherein the arrangement contains at least one control device for the provision of various functions in the motor vehicle, wherein the control device is designed to carry out the method for the activation of functions in a motor vehicle, wherein the control device is arranged in the motor vehicle and connected to at least one data entry device and at least one data output device.

In particular, at least one control device can be provided for the provision of various functions in the motor vehicle. Such a control device implements, for example, a driver assistance system or several driver assistance systems with the associated functions in a motor vehicle. Such a control device can also be provided to control the procedure according to the disclosure for activating functions in motor vehicles.

The control device is arranged in the motor vehicle and connected to at least one device for data entry. Through this data entry device, the control device receives input from the user for controlling the motor vehicle and carrying out training units for functions of the motor vehicle to be activated.

The control device is also connected to at least one device for data output arranged in the motor vehicle. This device for data output is used to output information to the user, for example visually, acoustically, or haptically, when controlling the motor vehicle and when carrying out training units for functions of the motor vehicle that are to be activated.

In an example, a device for data output can be a vehicle display or a head-up display.

For the output of visual information or feedback, especially when carrying out training units for functions to be activated of the motor vehicle, a device for data output such as a vehicle display is provided, which may be arranged, for example, in an area of a center console of the motor vehicle. A head-up display arranged in the motor vehicle can also be used to output visual information or feedback. In addition, visual information can also be provided by illuminating input keys or by means of corresponding LEDs (light-emitting diodes) to indicate various states in the motor vehicle.

Furthermore, for example, loudspeakers installed in the motor vehicle can be used to output acoustic information to the user.

In a further example, it may be that a device for data entry is in the form of motor vehicle control elements or a display with touchscreen technology.

As a device for data entry, control elements such as switches, control buttons, or levers, such as a turn signal lever, can be used in the motor vehicle, which are connected to the control device at least for the transmission of information. In addition, input from the user can also be received by the control device via a display with touchscreen technology. In addition, acoustic user data entry via a microphone arranged in the vehicle is possible.

In an example, the control device can be arranged in the motor vehicle and contains a data memory or is connected to a data memory, wherein the data memory is designed at least for the storage of a user account.

In order to implement the arrangement advantageously, it may be provided that the control unit contains a data memory. In this data memory, for example, data processing instructions for the implementation of requirements for the activation of functions in motor vehicles are stored and retrieved at the appropriate time. In addition, information about a user account, preferably about several user accounts, is stored in this data memory, which is read by the control device during the course of the method for activating functions in motor vehicles and is used accordingly to activate functions for the user of the user account.

In an alternative version, the data memory is arranged in the motor vehicle and connected to the control device, wherein the task or functionality of the data memory described above remains the same.

It is also possible that the control device is connected to a data transmission interface through which information is transferred to a user account of a user of the motor vehicle.

By means of such a data transmission interface, information can be transferred to a user account of a specific user that is stored on an external, mobile data carrier, to the data memory arranged in the control device or to the data memory connected to the control device. In addition, information about a user account of a specific user that is stored in the data memory arranged in the control device or in the data memory connected to the control device can be transmitted to the external, mobile data carrier.

It can be advantageous if the interface is a USB interface or an interface set up for wireless data transmission.

The interface used is a USB interface that works according to a USB standard, by means of which the user connects his or her USB stick to the control device in the motor vehicle.

Alternatively, an interface is used, for example, which is set up for wireless data transmission according to a WLAN protocol or an NFC protocol.

In a further example, a function activated after a successfully completed training course may be activated for a user for a specified number of starts of the motor vehicle or for a specified time. After expiration of the starts or the time has elapsed, the user is asked to prove successful completion of a training again in order to be able to continue using the corresponding function without restrictions. If this user does not successfully complete the specified training within a specified time or a specified number of starts of the motor vehicle, the relevant function will be at least partially blocked for this user.

### BRIEF DESCRIPTION OF THE DRAWINGS

Further advantageous designs of the invention are disclosed in the dependent claims and the following description of figures. In the figures:

FIG. 1 shows an exemplary classification of the functions of the motor vehicle and the characteristics thereof determined by the owner of the motor vehicle;

FIG. 2 shows a process for activating functions to be activated, which can be both a basic function and an extended function;

FIG. 3 shows a data processing device for carrying out training for activating a function to be activated;

FIG. 4 shows a device for data output in the motor vehicle;

FIG. 5 shows other devices for data output in the motor vehicle; and

FIG. 6 shows an exemplary schematic view of the arrangement in the motor vehicle.

In the different figures, the same parts are always provided with the same reference signs, which is why they are usually only described once. The terms “first”, “second”, etc. used below and above are for the purpose of distinction only. In particular, their use is not intended to imply the order or priority of the objects mentioned in connection with these terms.

### DESCRIPTION

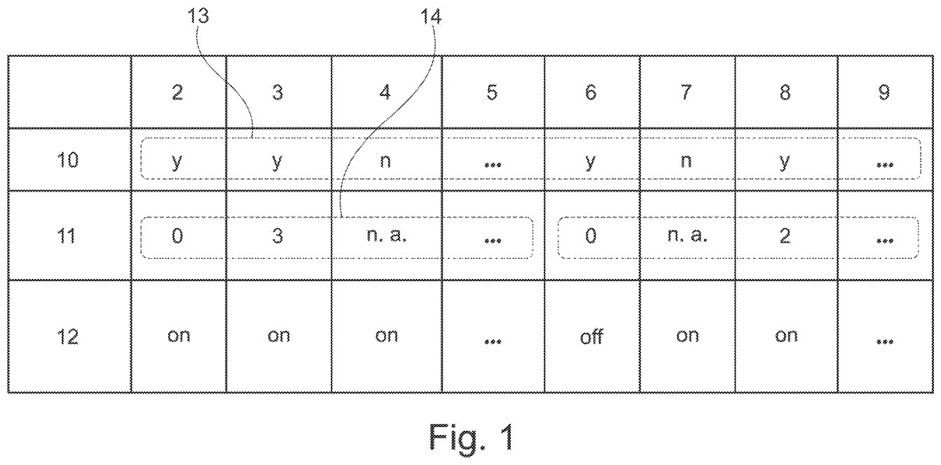

FIG. 1 shows an exemplary classification of the functions of the motor vehicle 1 and the characteristics thereof determined by an owner of the motor vehicle 1.

In the top row of the table in FIG. 1, a first basic function 2, a second basic function 3, a third basic function 4 and a nth basis function 5 are shown. Furthermore, in the top row of the table of FIG. 1, a first extended function 6, a second extended function 7, a third extended function 8 and an nth extended function 9 are shown. In this context, it may be provided that some functions of the motor vehicle that are indispensable for the operation of the motor vehicle have already been firmly classified by the vehicle manufacturer as basic functions which the owner of the motor vehicle cannot change.

In the left column of the table of FIG. 1, a first label 10 “Training required” has been made in the plane of the drawing from top to bottom, a second label 11 “Available vehicle starts” and a third label 12 “Initial status of the function”.

In the second row of the table in FIG. 1, seen from above in the plane of the drawing, a statement is made about which functions are free functions and are thus immediately activated for the user. In this second row of the table in FIG. 1, a frame represented by a dash-dash line shows the decisions made by the owner of the motor vehicle 1 in a first determination 13 as to whether a basic function and/or an extended function for the user of the motor vehicle 1 is a free function which has the entry “n” (no) in the table in FIG. 1. The entry “n” means that no training is required for this basic function and/or extended function and that this free function is immediately available to the user.

In the event that a basic function and/or an extended function for the user of the motor vehicle 1 is a function to be activated which is only activated after successfully proven training, it has the entry “y” (yes) in the table of FIG. 1. The entry “y” means that training associated with this basic function and/or extended function is required and that this function will only be activated for the user upon proof of successfully completed training for this function. In the example of FIG. 1, training is required to use the first basic function 2, while the third basic function 4 is immediately activated and usable by the user.

In the third row of the table in FIG. 1, which is seen from above in the plane of the drawing, the second determination 14 of the number of possible starts of the motor vehicle 1 created by the owner of the motor vehicle 1 is entered. The number of starts of the motor vehicle 1 entered here determines how often the user can temporarily use a function to be activated without successful proof of training before the function is blocked. In the example of FIG. 1, three starts with the motor vehicle 1 are possible for the second basic function 3, in which the second basic function 3 can be used by the user, before the second basic function 3 is blocked for this user at the fourth start. The user can avoid the blocking by providing proof of the associated successfully completed training before the fourth start of the motor vehicle 1. The entry “n.a.” stands for “not available” or “not specified” because for functions for which no training is required, it is not necessary to assign a number of available starts.

In the fourth row of the table in FIG. 1, seen from above in the plane of the drawing, an initial status of the functions is shown, which a user finds when starting the motor vehicle 1 for the first time. In the example of FIG. 1, the first extended function 6 is switched off and unusable for the user, which is indicated by the entry “off”. The first basic function 2, the second basic function 3, the third basic function 4 and other possible basic functions are indispensable functions of the motor vehicle for the operation of the motor vehicle and are therefore always switched to “on” or these functions cannot be switched off. The third extended function 8 is available to the user at the first start, which is indicated by the entry “on”, but the number of possible starts is limited to two starts.

In summary, it can be read from the table of FIG. 1 that for the first basic function 2, which is always switched on, no start is possible without proof of successfully completed training, since the owner has set the number of possible starts without training to zero, that for the second basic function 3, which is always switched on, three starts are possible, until successful training has to be proven and that the third basic function 4, which is always switched on, is available immediately and without training.

Furthermore, it can be read from the table of FIG. 1 that the first extended function 6 cannot be used without proof of successfully completed training, that the second extended function 7 is available immediately and without training, and that the third extended function 8 can be used for two starts and that successful training must be proven before the third start to be able to continue using the third extended function.

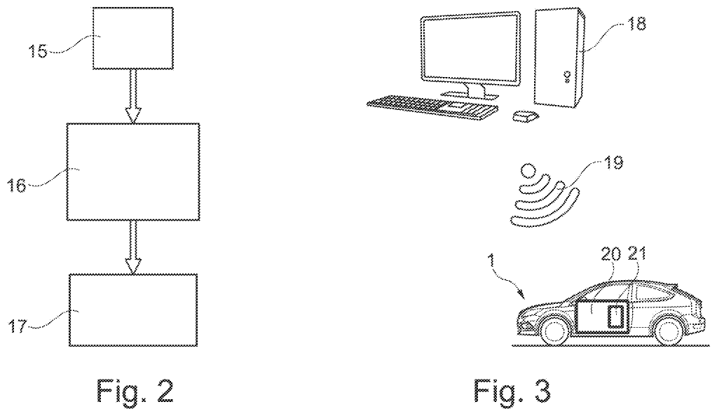

FIG. 2 shows a process for activating functions to be activated, which can be both a basic function and an extended function.

The process of activating a function to be activated begins with a training process 15, which is assigned to the function to be activated and is carried out by the user in the motor vehicle 1, for example. If the user successfully completes the training process 15, which is checked, for example, in the form of questions about the trained function, the user receives a proof of training 16, which corresponds to a successfully proven training. On the basis of the proof of training 16, the corresponding function is activated in the form of a function activation 17. Information about successfully proven trainings and the associated activated functions is stored in the user account of the corresponding user, which is not shown in FIG. 2.

FIG. 3 shows a data processing device 18 for carrying out training for activating a function to be activated.

The training for activating a function to be activated for a user of the motor vehicle 1 can, as shown in FIG. 3, be carried out, for example, by means of a data processing device 18 such as a computer with associated input and output devices. For this purpose, the user can, for example, use the data processing device 18 to call up an application or website of the vehicle manufacturer on which such training opportunities for various vehicle types of the manufacturer are offered.

For the implementation of such training opportunities, the data processing device 18 has an interface that is not shown in FIG. 3, via which information about a user account can be transferred from an external, mobile data carrier to the data processing device 18 and vice versa. This ensures that the user can access and edit the training units available to them via the website and that information about a successfully completed training unit is stored in the user account.

In addition, the data processing device 18 can be connected to an interface 19 for wireless communication. This interface 19 is designed to exchange data with the motor vehicle 1 according to a protocol for wireless data transmission. Such an exchange of data between the data processing device 18 and the motor vehicle 1 can be carried out, for example, by means of a WLAN protocol. In this case, a corresponding interface for data transmission according to the WLAN protocol is also provided in the motor vehicle 1. The transmitted information about a user account is stored, for example, in a data memory 21 arranged in the control device 20 and thus in the motor vehicle 1.

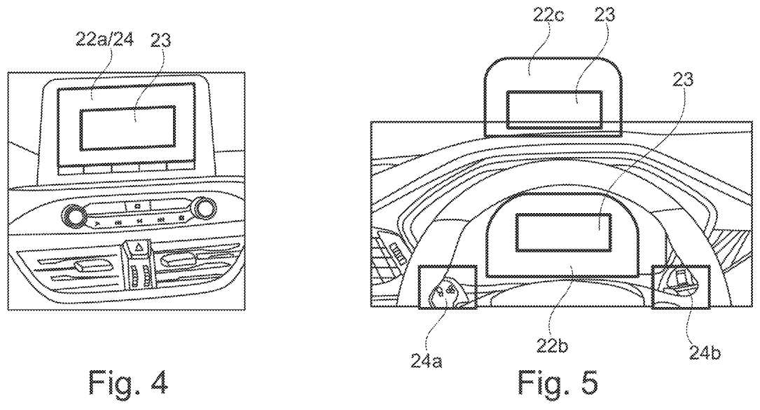

FIG. 4 shows a device for data output 22a in the motor vehicle 1.

In the area of a center console of the motor vehicle 1, the device for data output 22a is arranged in the form of a vehicle display. On this device for data output 22a, a text field 23 is displayed, in which the user of the motor vehicle 1 is shown information about the method for activating functions in a motor vehicle 1. Alternatively or additionally, sound output to the user of the motor vehicle 1 can also be carried out.

In the event that the vehicle display is equipped with touchscreen technology, the vehicle display in FIG. 4 may also be a data entry device 24 through which the user of the motor vehicle 1 can enter information. Such input of information is used in particular when carrying out a training unit for functions to be activated, which is carried out in the motor vehicle 1.

For example, in the text field 23 the following information can be displayed to the user:
“This function is not available. Training is required.”
“Training for this function has been successfully proved. The function is now available.”
“Training is required for the basic air conditioning function. There are still two starts left with the motor vehicle.”
“Proof of training of the basic air conditioning function has been provided. The basic air conditioning function can now be used without restrictions.”

FIG. 5 shows further devices 22b and 22c for data output to the user in the motor vehicle 1.

According to the disclosure, a display usually arranged in the area of the steering wheel in the motor vehicle 1 can be used as a device 22b for data output, which for example, displays information about a speed, mileage, state of charge or range and others.

On this device 22b for data output, the user of the motor vehicle 1 is also shown information about the method for activating functions in a motor vehicle 1.

FIG. 5 also shows a device 22c for data output, which is implemented as a head-up display. As an alternative or in addition to the devices 22a or 22b for data output, information about the method for activating functions in a motor vehicle 1 is displayed to the user of the motor vehicle 1 via the device 22c for data output.

For the output or display of information about the activation of functions in a motor vehicle 1, a text field 23 is also displayed on the device 22b for data output and/or the device 22c for data output. Examples of information that can be displayed in these text fields 23 have already been listed above.

FIG. 5 shows two data entry devices 24a and 24b as examples. Using operating elements on the steering wheel, switches, or levers, such as a turn signal lever arranged in the area of the steering wheel, the user of the motor vehicle can make inputs that are processed, for example, during a training process 15 or a training unit.

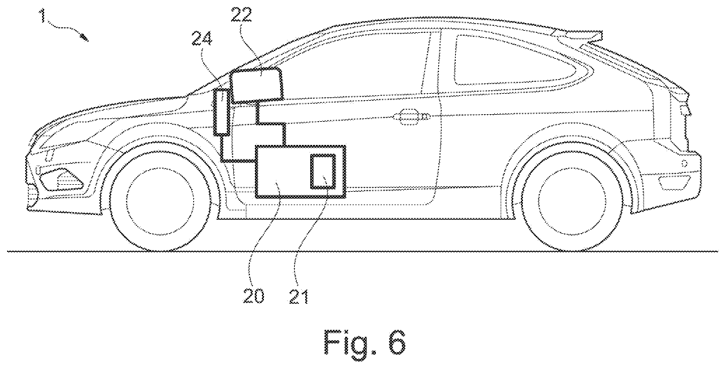

FIG. 6 shows an exemplary schematic view of the arrangement according to the disclosure in the motor vehicle 1.

The arrangement arranged in the motor vehicle 1 for the activation of functions in a motor vehicle 1 contains at least one control device 20 for the provision of various functions in the motor vehicle 1. This control device 20 is also designed to activate functions in a motor vehicle 1.

As shown in FIG. 6, the control device 20 is arranged in the motor vehicle 1 and connected to a data memory 21. In the version according to FIG. 6, the data memory 21 is arranged in the control device 20.

Data processing instructions for the implementation of the method for the activation of functions in motor vehicles 1 are stored in this data memory 21 and are retrieved during the execution of the method and processed in the control device 20. In addition, information about a user account, preferably about several user accounts, is stored in this data memory 21, and is read by the control device 20 during the course of the method for activating functions in motor vehicles 1 and is used accordingly for activating functions for the current user.

The control device 20 is connected to at least one device 22 for data output, such as a head-up display. The control device 20 is arranged in the motor vehicle 1 and is connected to at least one device 24 for data entry.

### LIST OF REFERENCE CHARACTERS

1 motor vehicle
2 first basic function
3 second basic function
4 third basic function
5 nth basic function
6 first extended function
7 second extended function
8 third extended function
9 nth extended function
10 first inscription
11 second inscription
12 third inscription
13 first determination
14 second determination
15 training process
16 proof of training
17 function activation
18 data processing device
19 wireless communication interface
20 control device
21 data memory
22 data output device
23 text field
24 data entry device

1-13. (canceled)

14. A method for activating functions in a motor vehicle, comprising:
classifying functions of the motor vehicle into basic functions and extended functions;
making a first determination of first basic functions and/or extended functions that are free functions for the user of the motor vehicle, which are activated immediately, and second basic functions and/or extended functions that are functions to be activated only after successfully proven training;
making a second determination of a number of possible starts of the motor vehicle with which functions to be activated only after successfully proven training can be used provisionally and to a limited extent, wherein the functions to be activated only after successfully proven training are only fully activated after successfully proven training; and
activating the free functions for the user when using the motor vehicle for a first time, activating the functions to be activated given successfully proven training, or blocking the functions to be activated when the number of possible starts is reached.

15. The method of claim 14, wherein the classification of the functions and the first determination and the second determination are carried out by an owner of the motor vehicle for all users of the motor vehicle.

16. The method of claim 14, wherein the training for the functions to be activated is carried out in the motor vehicle and the result of the training is assigned to a user and stored in a user account in the motor vehicle.

17. The method of claim 14, wherein the training for the functions to be activated is carried out by a data processing device, and in the event of successfully completed training, proof of the successfully completed training is output and assigned to a user account of the user.

18. The method of claim 17, wherein the output is carried out to a data carrier, or the output is carried out via an interface for wireless communication with the motor vehicle.

19. The method of claim 14, wherein, in the event that a training unit for a function is only partially successfully completed, the function related to the training is only partially or temporarily released.

20. The method of claim 14, wherein the information assigned to the user in the user account about successfully completed training courses for the functions to be activated is transferred to motor vehicles of the same type, whereby further training for this user is no longer required.

21. A system, comprising:
a control device for the provision of various functions in the motor vehicle, wherein the control device is arranged in the motor vehicle and connected to a device for data input and at a device for data output, and is configured to:
make a first determination of first basic functions and/or extended functions that are free functions for the user of the motor vehicle, which are activated immediately, and second basic functions and/or extended functions that are functions to be activated only after successfully proven training;
make a second determination of a number of possible starts of the motor vehicle with which functions to be activated only after successfully proven training can be used provisionally and to a limited extent, wherein the functions to be activated only after successfully proven training are only fully activated after successfully proven training; and
activate the free functions for the user when using the motor vehicle for a first time, activating the functions to be activated given successfully proven training, or blocking the functions to be activated when the number of possible starts is reached.

22. The system of claim 21, wherein the device for data output is a vehicle display or a head-up display.

23. The system of claim 21, wherein the device for data input includes controls of the motor vehicle or a display with touchscreen technology.

24. The system of claim 21, wherein the control device contains a data memory or is arranged in the motor vehicle and connected to a data memory, wherein the data memory is designed at least for storing a user account.

25. The system of claim 21, wherein the control device is connected to a data transmission interface through which information is transmitted to a user account of a user of the motor vehicle.

26. The system of claim 21, wherein the classification of the functions and the first determination and the second determination are carried out by an owner of the motor vehicle for all users of the motor vehicle.

27. The system of claim 21, wherein the training for the functions to be activated is carried out in the motor vehicle and the result of the training is assigned to a user and stored in a user account in the motor vehicle.

28. The system of claim 21, wherein the training for the functions to be activated is carried out by a data processing device, and in the event of successfully completed training, proof of the successfully completed training is output and assigned to a user account of the user.

29. The system of claim 27, wherein the output is carried out to a data carrier, or the output is carried out via an interface for wireless communication with the motor vehicle.

30. The system of claim 21, wherein, in the event that a training unit for a function is only partially successfully completed, the function related to the training is only partially or temporarily released.

31. The system of claim 21, wherein the information assigned to the user in the user account about successfully completed training courses for the functions to be activated is transferred to motor vehicles of the same type, whereby further training for this user is no longer required.
